(19) United States
(12) Patent Application Publication
(10) Pub. No.: US 2024/0384744 A1
(43) Pub. Date: Nov. 21, 2024

(54) BREAK-AWAY BOLT

(71) Applicants: Melvin D. PLUMMER, Los Angeles, CA (US); Niklas Seyferth, Los Angeles, CA (US)

(72) Inventors: Melvin D. PLUMMER, Los Angeles, CA (US); Niklas Seyferth, Los Angeles, CA (US)

(21) Appl. No.: 18/197,392

(22) Filed: May 15, 2023

(51) Int. Cl. F16B 31/06

(52) U.S. Cl. CPC F16B 31/06

(57) ABSTRACT

A double-sided break-away bolt including a precision weakened area enabling the bolt to break into two or more sections upon predefined conditions is provided. The break-away bolt is adapted to connect a fire hydrant to a check valve with the weakened portion generally positioned at the junction between the hydrant and the valve. A force applied to the fire hydrant in a direction generally perpendicular to the break-away bolt (e.g., by a car colliding with the hydrant) may cause the break-away bolt to break at the weakened area. This in return facilitates the separation of the hydrant from the check valve allowing the check valve to close. The break-away bolt also includes a gripping element that becomes exposed upon the breaking of the bolt to facilitate the removal of the bolt from the check valve for replacement.

### FIELD OF THE INVENTION

This invention relates to bolts, including break-away bolts.

### BACKGROUND

As is known in the art, many fire hydrants throughout the world are configured atop out check valves that automatically terminate the water supply to the hydrant upon the hydrant being severed from the valve (e.g., when an automobile collides with the hydrant). The fire hydrants are typically connected to the check valves using what is known as “break-away bolts” designed to break apart at a desire location (e.g., at the junction between the hydrant and the valve) upon a predefined force applied to the hydrant. In this way, when a force of a predefined magnitude is applied to the side of the hydrant, the break-away bolt(s) may break thereby releasing the hydrant and allowing the check valve to close.

However, once a hydrant has been severed from the check valve, a portion of the severed break-away bolt(s) remain secured in the upper portion of the valve and are difficult to remove. In fact, reconfiguring the hydrant onto the check valve after breakage often requires the complete removal of the check valve from the water main system, causing water outages and increased labor costs.

Accordingly, there is a need for a break-away bolt including a removal mechanism to facilitate the removal of a severed bolt from a closed check valve. There also is a need for a break-away bolt and check valve combination that facilitates the easy reconfiguration of the hydrant onto the check valve. These and other issues will be addressed herein.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a perspective view of a break-away bolt according to exemplary embodiments hereof;

FIG. 2 shows a side view of the break-away bolt of FIG. 1 according to exemplary embodiments hereof;

FIG. 3 shows a cross-sectional side view of a break-away bolt according to exemplary embodiments hereof;

FIG. 4 shows a break-away bolt inserted into an opening according to exemplary embodiments hereof;

FIG. 5 shows a break-away bolt used to attach a fire hydrant to a check valve according to exemplary embodiments hereof;

FIG. 6 shows the fire hydrant of FIG. 5 being displaced from the check valve due to an applied force according to exemplary embodiments hereof;

FIG. 7 shows a remaining portion of the break-away bolt configured with the check valve after the displacement of the fire hydrant of FIG. 6 according to exemplary embodiments hereof;

FIG. 8 shows a top view of an exposed gripping element within an opening according to exemplary embodiments hereof; and

FIG. 9 shows a plurality of break-away bolts configured with a check valve according to exemplary embodiments hereof.

### DETAILED DESCRIPTION OF EXEMPLARY EMBODIMENTS

In general, the break-away bolt according to exemplary embodiments hereof provides a double-sided bolt including a precision weakened area enabling the bolt to break into two or more sections upon predefined conditions. The break-away bolt includes a first attachment portion for attaching to a first item (e.g., a first flange), a second attachment portion for attaching to a second item (e.g., a second flange), and a weakened area between the first and second attachment portions. In general, the break-away bolt is adapted to connect the first item to the second item with the weakened portion generally positioned at the junction between the first and second items. In this way, a force applied to the first item or to the second item in a direction generally perpendicular to the break-away bolt may cause the break-away bolt to break at the weakened area. This in return may facilitate the separation of the second item from the first item. As will be described in other sections, the break-away bolt also includes a gripping element configured with the first attachment portion to facilitate the removal of the first attachment portion upon breakage of the bolt.

In some embodiments, the bolt's first attachment portion is designed to be received into a receiving opening with a specific arrangement of inner threads, circumferential ledges, and varying diameters to facilitate the bolt's desired performance. This will be described in other sections.

For the purposes of this specification, the break-away bolt, and the receiving opening within which the break-away bolt may be attached will be described predominantly with respect to its use with attaching a fire hydrant to a break-away check valve such as described in U.S. patent application Ser. No. 16/382,124, filed Apr. 19, 2019, now U.S. Pat. No. 11,187,332, the entire contents of which are hereby fully incorporated herein by reference for all purposes. However, it is understood that the break-away bolt and/or the receiving opening may be used to attach any first item with any second item that may benefit from the functionalities of the bolt and opening.

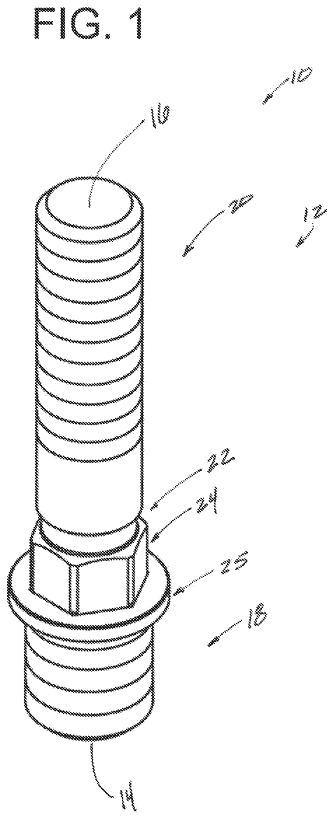

The break-away bolt will now be described in detail with reference to FIGS. 1-9.

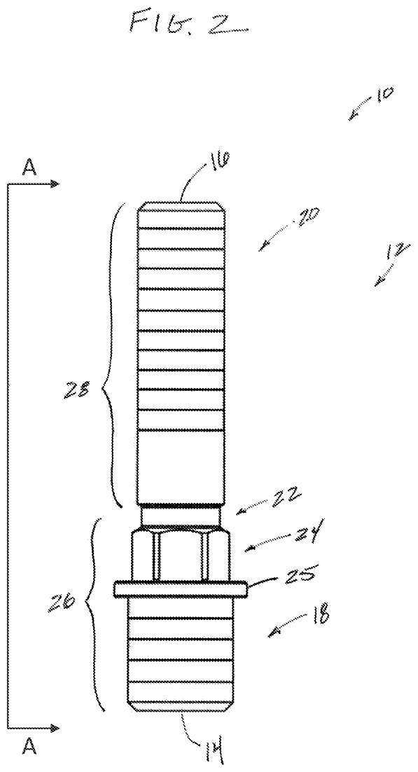

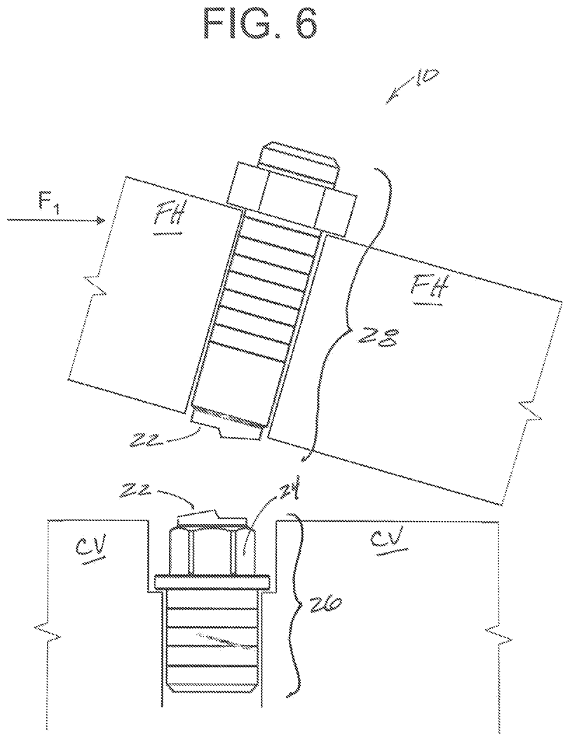

In one exemplary embodiment hereof, as shown in FIGS. 1-2, the break-away bolt 10 (also referred to herein as simply the bolt 10) includes an elongate body 12 with a first end 14 and a second end 16. FIG. 1 shows a perspective view of the bolt 10 and FIG. 2 shows a side view of the same. The bolt's first end 14 includes a first attachment portion 18 and the bolt's second end 16 includes a second attachment portion 20. The bolt's body 12 includes a shear location 22 generally between the first attachment portion 18 and the second attachment portion 20. As will be described herein, the bolt 10, upon predefined conditions, is designed to break apart at the shear location 22 into two break-apart portions 26, 28 (see FIGS. 2 and 6), with a first break-apart portion 26 including the first attachment portion 18 and a second break-apart portion 28 including the second attachment portion 20. In addition, the bolt 10 includes a gripping element 24 generally adjacent the first attachment portion 18 towards the shear location 22 for gripping the first attachment portion 18 to facilitate its removal after breakage of the bolt 10. The bolt 10 also may include a circumferential ring 25 located between the gripping element 24 and the first attachment portion 18 and extending outward from the bolt's body 12. The break-away bolt 10 may include additional elements as necessary for the bolt 10 to perform its functionalities.

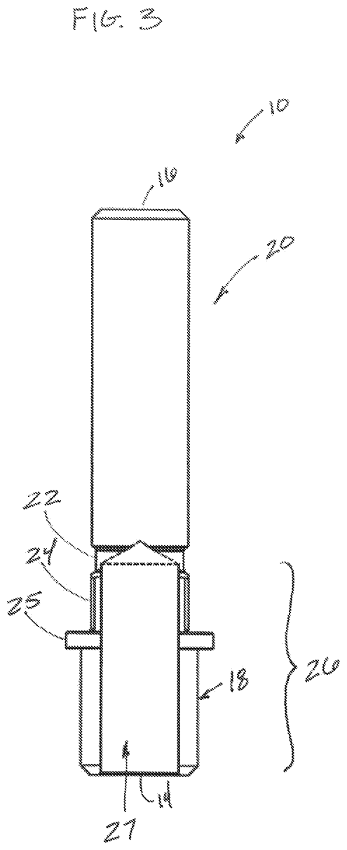

FIG. 3 shows the cross-section of the break-away bolt 10 taken from the perspective of cutlines A-A of FIG. 2. As shown, in some embodiments, the bolt's first break-apart portion 26 may include a hollow portion 27 (e.g., a bored-out portion) that may extend from the bolt's first end 14 (e.g., its bottom end) upward to about the bolt's shear location 22. In this way, the bolt's first break-apart portion 26 may be weakened compared to the bolt's second break-apart portion 28. In some embodiments, the hollow portion 27 may be formed using a boring tool (e.g., a drill bit) including a sharpened conical tip resulting in the bored-out hollow portion 27 including a conical upper end, however, this may not be required. In some embodiments, the diameter of the inner bore withing section 26 is about 0.50″ leaving a wall thickness in this area of about 1/16″-⅛″ but it is understood that other diameters and wall thicknesses also may be used. In some embodiments, the diameter of the shear location 22 is about 0.56″ but it is understood that other diameters also may be used.

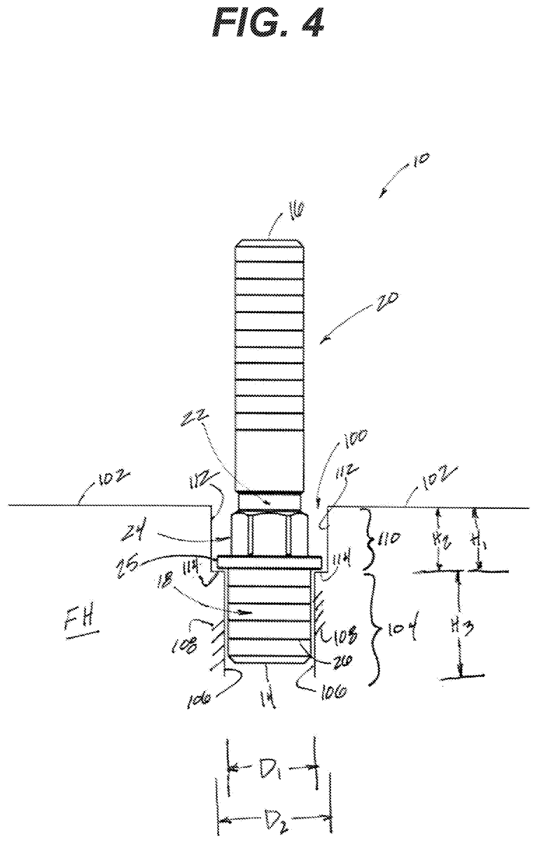

FIG. 4 shows a side view of the break-away bolt 10 configured within a receiving opening 100. In some embodiments, the receiving opening 100 may be located on an upper surface 102 of a break-away check valve CV to facilitate the attachment of the valve CV to a fire hydrant. In some embodiments, the receiving opening 100 includes a first opening portion 104 defined by first inner side walls 106 adapted to receive and secure the break-away bolt's first attachment portion 18. In some embodiments, the bolt's first attachment portion 18 includes outer threads 26 and the first inner side walls 106 include corresponding inner threads 108 adapted to engage the first attachment portion's outer threads 26. In this way, the bolt's first attachment portion 18 may be screwed into the opening's first opening portion 104 and be secured therein.

In some embodiments, as shown in FIG. 4, the receiving opening 100 includes a second opening portion 110 defined by second inner sidewalls 112, located generally above the first opening portion 104 and adapted to receive the break-away bolt's gripping element 24. The first opening portion 104 may include a first diameter D₁ and the second opening portion 110 may include a second diameter D₂ that, in some embodiments, may be greater than the first diameter D₁. The first opening portion 104 may be joined with the second opening portion 110 by a circumferential ledge 114 that may preferably be generally horizontal.

In some embodiments, as shown in FIG. 3, the bolt's first attachment portion 18 may be received into (e.g., screwed into) the opening's first opening portion 104 until the circumferential ring 25 abuts the circumferential ledge 114 thereby acting as a stop. In this way, the depth of the bolt's body 12 within the receiving opening 100 may be controlled. Accordingly, it may be preferable that the height H₃ of the first opening portion 104 be equal to or greater than the length of the bolt's first attachment portion 18. While the circumferential ring 25 is shown to extend around the entire circumference of the bolt's body 12, it is understood that the circumferential ring 25 may extend around one or more portions of the bolt's circumference or any combination thereof. In some embodiments, the bolt's body 12 may include surface textures (e.g., may be knurled or otherwise roughened) in area between the shearing location 22 and the second attachment portion 20 to assist in the gripping of the bolt 10 for insertion into the receiving opening 100.

In some embodiments, as shown in FIG. 3, with the bolt's first attachment portion 18 received and secured within the opening's first opening portion 104, and the bolt's circumferential ring 25 abutted against the opening's circumferential ledge 114, the bolt's gripping element 24 may be received into the opening's second opening portion 110. It may be preferable that in this configuration the top of the gripping element 24 be located at or slightly below the level of the check valve's upper surface 102. In this way, the entire height H₁ of the gripping element 24 and circumferential ring 25 combination may be received into the opening's second opening portion 110 (with height H₂). Accordingly, it may be preferable that H₁≤H₂. This arrangement may place the shear location 22 at or slightly above the level of the check valve's upper surface 102, and as will be described in other sections, may facilitate the shearing of the bolt 10 into a first break-apart portion 26 and a second break-apart portion 28 under predefined conditions (e.g., when a force is applied to the bolt 10).

In some embodiments as shown in FIGS. 1-3, the gripping element 24 extends about at least a portion of the circumference of the bolt's body 12. In this way, at least a portion of the gripping element 24 is circumferential with respect to the bolt body 12. In some embodiments, the gripping element 24 includes a hex section (also referred to as a hex head) that may be gripped from the side using a conventional wrench and/or from above (when the bolt 10 has broken and the second break-apart portion 28 has been removed thereby exposing the top of the gripping element 24) using a socket wrench. In this way, the first attachment portion 18 may be gripped from above and unscrewed from within the first opening portion 104 once the bolt 10 has been broken. It is understood that the gripping element 24 may include other types of gripping elements (such as a square head and/or any other shaped head) that may be gripped preferably from above.

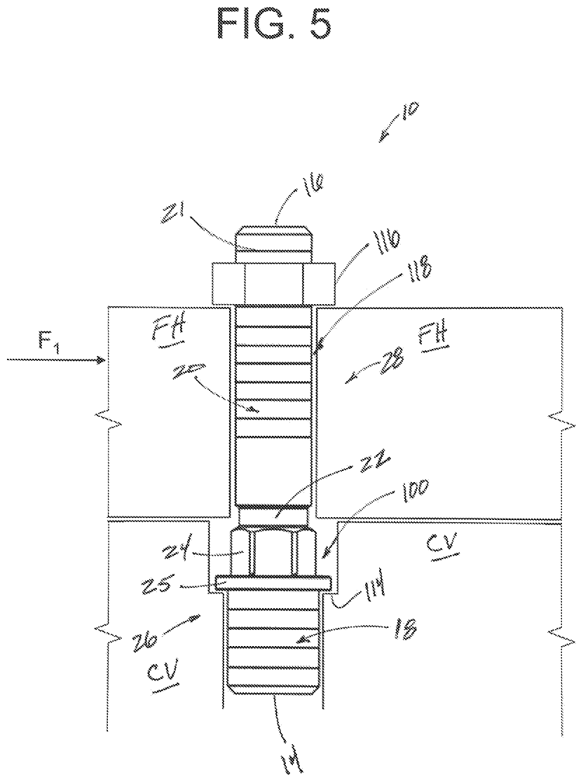

In some embodiments, as shown in FIG. 5, the bolt's second attachment portion 20 may include outer threads 21 for engagement with a threaded nut 116. The fire hydrant FH may include a through-hole 118 adapted to receive the bolt's second attachment portion 20 from the through-hole's underneath side to its top side. The length of the bolt's second attachment portion 20 may be chosen such that the bolt's second end 16 as well as a portion of the bolt's second attachment portion 20 may extend out the through-hole's 118's top side when the fire hydrant FH is placed atop the check valve CV as shown. A threaded nut 116 may be placed on the bolt's second end 16 extending out the top side of the through-hole 118 and tightened, thereby attaching the second attachment portion 20 to the fire hydrant FH.

In the arrangement shown in FIG. 5, with the fire hydrant FH attached atop the check valve CV using the break-away bolt 10 as described herein, a force F1 applied to the fire hydrant FH (e.g., by an automobile striking the fire hydrant FH also referred to as a hydrant strike) may cause the bolt 10 to break at the shear location 22, thereby releasing the fire hydrant FH and the bolt's second break-apart portion 28 from the check valve CV and the bolt's first break-apart portion 26. This is shown in FIG. 6. Given the above, it may be preferable for the tensile strength of the bolt's shearing location 22 be chosen such that the bolt 10 may break during a hydrant strike prior to the fire hydrant FH and/or water main system becoming damaged.

It is notable that the junction between the bolt's first break-apart portion 26 and the receiving opening 100 may be tight and rigid, thereby holding the first break-apart portion 26 generally stationary during the breaking of the bolt 10. Given this, the force F₁ may cause the fire hydrant FH and to shear the bolt 10 at its shearing location 22 located just above the upper surface 102 of the check valve CV.

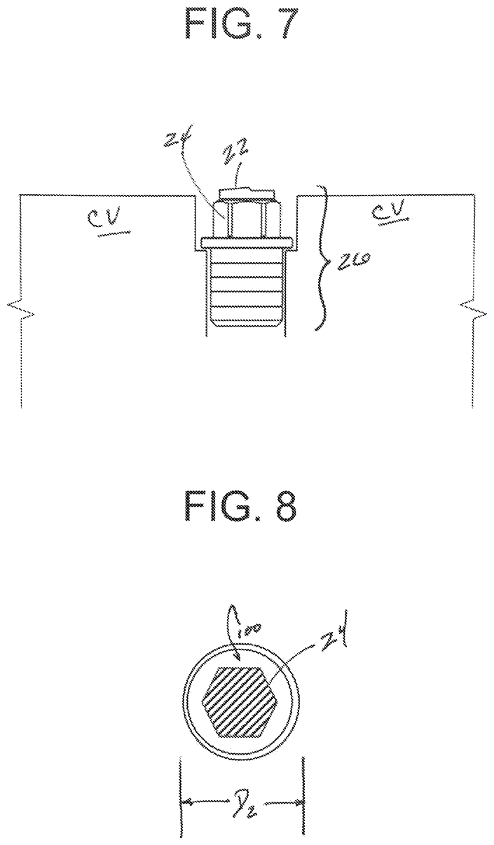

FIG. 7 shows a side view of the bolt's first break-apart portion 26 left intact within the receiving opening 100 after the applied force F1 caused the fire hydrant FH and the bolt's second break-apart portion 28 to be removed, and FIG. 8 shows the same from above.

With the bolt's second break-away portion 28 removed, the bolt's gripping element 24 may be exposed from the top as shown in FIG. 8. Subsequently, a socket wrench may be placed over the gripping element 24 from above and used to remove (e.g., unscrew) the first break-apart portion 26 from the receiving opening 100. In this way, the break-away bolt 10 may be replaced for reattachment of the fire hydrant FH to the check valve CV.

Given the above, it may be preferable to choose a diameter D₂ of the opening's second opening portion 110 to be wide enough to allow the socket wrench to be inserted onto the gripping element 24 between the gripping element 24 and the inner sidewalls 112.

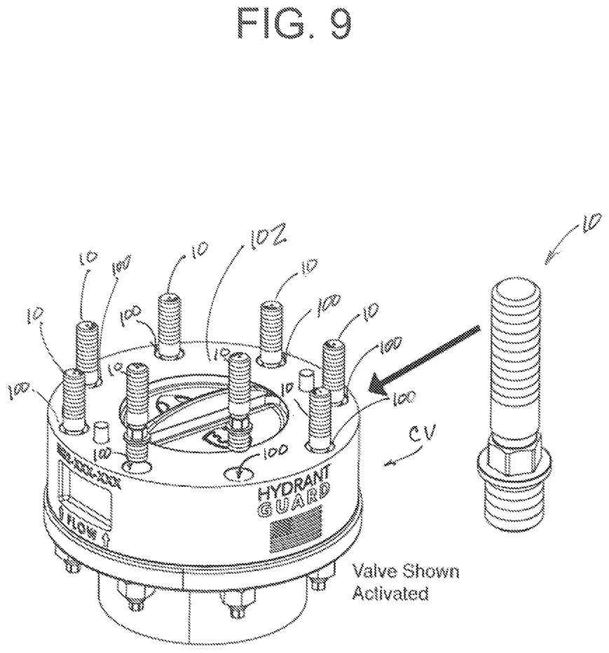

FIG. 9 shows a plurality of break-away bolts 10 configured within receiving openings 100 in the upper surface 102 of a break-away check valve CV.

It is understood that the steps described above are meant for demonstration and that additional steps may be performed, not all of the described steps may be performed, and the steps may be taken in different orders. It also is understood that the scope of the break-away bolt 10 is not limited in any way by the steps taken during its use.

It also is understood that any aspect and/or element of any embodiment of the break-away bolt 10 described herein or otherwise may be combined with any other aspect and/or element of any other embodiment described herein or otherwise in any way to form additional embodiments of the bolt 10 all of which are within the scope of the bolt 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A break-away bolt comprising:
an elongate member with a circumference and a first end and a second end, the elongate member including a first attachment portion towards the first end and adapted to attach the elongate member to a first item, a second attachment portion towards the second end and adapted to attach the elongate member to a second item, and a shearing location between the first and second attachment portions adapted to break upon predefined conditions;
a gripping element coupled about at least a portion of the circumference between the first and second attachment portions.

2. The break-away bolt of claim 1 wherein the predefined conditions include an external force being applied to the first item.

3. The break-away bolt of claim 1 wherein the shearing location includes a weakened section.

4. The break-away bolt of claim 1 wherein the shearing location is between the gripping element and the second attachment portion.

5. The break-away bolt of claim 1 wherein the gripping element includes a hex section.

6. The break-away bolt of claim 1 wherein the elongate member includes a stop coupled to at least a portion of the outer circumference.

7. The break-away bolt of claim 6 wherein the stop includes a ring.

8. The break-away bolt of claim 6 wherein the stop is between the first attachment portion and the gripping element.

9. The break-away bolt of claim 1 wherein at least a portion of the first attachment portion includes a hollow portion.

10. The break-away bolt of claim 8 wherein the hollow portion extends from the first end towards the shearing location.

11. The break-away bolt of claim 1 wherein the first attachment portion and/or the second attachment portion includes outer threads.
